(19) United States
(12) Patent Application Publication
(10) Pub. No.: US 2011/0052995 A1
(43) Pub. Date: Mar. 3, 2011

(54) ACTIVE MATERIAL, ELECTRODE CONTAINING THE SAME, LITHIUM SECONDARY BATTERY PROVIDED THEREWITH AND METHOD FOR MANUFACTURE OF THE ACTIVE MATERIAL

(75) Inventors: Atsushi SANO, Tokyo (JP); Keitaro OTSUKI, Tokyo (JP); Yosuke MIYAKI, Tokyo (JP); Takeshi TAKAHASHI, Tokyo (JP); Akiji HIGUCHI, Kyoto-shi (JP)

(73) Assignee: TDK CORPORATION, Tokyo (JP)

(21) Appl. No.: 12/868,142

(22) Filed: Aug. 25, 2010

(30) Foreign Application Priority Data
Aug. 28, 2009 (JP) P2009-198466
Sep. 4, 2009 (JP) P2009-204623

(51) Int. Cl. H01M 4/485; C01B 25/30; B32B 5/16

(52) U.S. Cl. 429/231.5; 423/306; 428/402

(57) ABSTRACT

A method for manufacturing an active material comprising:
a hydrothermal synthesis step of heating under pressure, a mixture containing a lithium source, a vanadium source, a phosphoric acid source, water and a water-soluble polymer having a weight average molecular weight of from 200 to 100,000,
wherein the ratio of the total mole number of repeating units of the whole water-soluble polymer to the mole number of the vanadium atoms is from 0.02 to 1.0, to produce a precursor of LiVOPO₄ having a β-type crystal structure; and
a firing step of heating the precursor of LiVOPO₄ having a β-type crystal structure to obtain LiVOPO₄ having a β-type crystal structure.

### BACKGROUND OF THE INVENTION

1. Field Of The Invention

The present invention relates to an active material, an electrode containing the same, a lithium secondary battery provided therewith, and a method for manufacturing the active material.

2. Related Background Art

It is known that Li can reversibly be inserted to or de-inserted from a crystal represented by LiVOPO₄. In Japanese Patent Application Laid-Open No. 2004-303527, there is disclosed that LiVOPO₄ having a β-type crystal structure (orthorhombic) and LiVOPO₄ having a α-type crystal structure (triclinic) are prepared by the solid phase method and that they are used as electrode active materials for non-aqueous electrolyte secondary batteries. There is further described that the discharge capacity of a non-aqueous electrolyte secondary battery with LiVOPO₄ having the β-type crystal structure is greater than that with LiVOPO₄ having the α-type crystal structure (triclinic).

In J. Baker et al., J. Electrochem. Soc., 151, A796 (2004), there is disclosed a method for preparing LiVOPO₄ having a β-type crystal structure in which VOPO₄ and Li₂CO₃ are heated in the presence of carbon, and Li₂COⱼ is reduced with the carbon (carbothermal reduction method (CTR method)).

### SUMMARY OF THE INVENTION

The active material containing LiVOPO₄ having a β-type crystal structure obtained by the method described either in Japanese Patent Application Laid-Open No. 2004-303527 or in J. Baker et al., J. Electrochem. Soc., 151, A796 (2004) is, however, incapable of producing a large discharge capacity with a high rate characteristic.

The object of the present invention is, therefore, to provide an active material capable of producing a large discharge capacity with a high rate characteristic, an electrode containing it, a lithium secondary battery provided with the electrode and a method for manufacturing the active material.

As a result of repeatedly conducting diligent studies in order to achieve the above-mentioned object, the present inventors found that a lithium source, a vanadium source, a phosphoric acid source, water and a water-soluble polymer having a weight average molecular weight of from 200 to 100,000 are mixed in such a manner that the ratio of the total mole number of repeating units of the whole water-soluble polymer to the mole number of the vanadium atoms is from 0.02 to 1.0, and the mixture is heated under pressure to produce a precursor of LiVOPO₄ having a β-type crystal structure. They further found that the precursor is fired to obtain LiVOPO₄ having a small average particle diameter and a large proportion of LiVOPO₄ with a β-type crystal structure, which has resulted in the completion of a first invention.

Specifically, the first invention provides a method for manufacturing an active material comprising: a hydrothermal synthesis step of heating under pressure, a mixture containing a lithium source, a vanadium source, a phosphoric acid source, water and a water-soluble polymer having a weight average molecular weight of from 200 to 100,000, wherein the ratio of the total mole number of repeating units of the whole water-soluble polymer to the mole number of the vanadium atoms is from 0.02 to 1.0, to produce a precursor of LiVOPO₄ having a β-type crystal structure; and a firing step of heating the precursor of LiVOPO₄ having a β-type crystal structure to obtain LiVOPO₄ having a β-type crystal structure.

The active material produced according to the first invention has a small average particle diameter and a large proportion of LiVOPO₄ with a β-type crystal structure; therefore, Li ion easily diffuses. A lithium ion secondary battery using such active material is capable of producing a large discharge capacity with a high rate characteristic. The reason LiVOPO₄ with a small average particle diameter can be obtained is not necessarily clear, but it is assumed to be what will be described below. To a mixture is added a water-soluble polymer having an weight average molecular weight of from 200 to 100,000 in such a manner that the ratio of the total mole number of repeating units of the whole water-soluble polymer to the atomic mole number of vanadium atoms is 0.02 to 1.0, thereby allowing the water-soluble polymer to coordinate to metal ions in the mixture. Thus, it is thought that a precursor having a high dispersibility of metal ions can be produced and the particle growth of the active material by heat treatment is suppressed in the step of firing the precursor. The reason why the proportion of LiVOPO₄ having a β-type crystal structure becomes large is also not necessarily clear, but it is assumed to be what will be described below. It is thought that the water-soluble polymer having an weight average molecular weight of from 200 to 100,000 influences the nuclear formation or nuclear growth during hydrothermal synthesis and promotes the growth of the β-type crystal structure.

Preferably, at the firing step, the precursor of LiVOPO₄ having a β-type crystal structure after the hydrothermal synthesis step is heated in an air atmosphere.

By heating the precursor of LiVOPO₄ having a β-type crystal structure after the hydrothermal synthesis step in an air atmosphere, it is possible to sufficiently remove the water-soluble polymer remaining in the precursor. This allows a large discharge capacity with a high rate characteristic to be obtained.

Preferably, the energy level of the Highest Occupied Molecular Orbital of the water-soluble polymer contained in the mixture is lower than −9.6 eV in the hydrothermal synthesis step. When the energy level of the Highest Occupied Molecular Orbital of the water-soluble polymer is lower than −9.6 eV, LiVOPO₄ having a β-type crystal structure can be obtained with ease.

Preferably, the water-soluble polymer comprises at least one selected from the group consisting of polyethylene glycol, copolymer of vinyl methyl ether and maleic acid anhydride, and polyvinylpyrrolidone.

When the water-soluble polymer comprises at least one selected from the group consisting of polyethylene glycol, copolymer of vinyl methyl ether and maleic acid anhydride, and polyvinylpyrrolidone, the particle growth of the active material by virtue of heat treatment is more easily suppressed in the firing step of the precursor.

Preferably, at the hydrothermal synthesis step, a reducing agent is further added to the mixture. This allows LiVOPO₄ having a β-type crystal structure to be obtained with ease.

As a result of repeatedly conducting diligent studies in order to achieve the above-mentioned object, the present inventors found that a mixture containing a lithium source, a vanadium source, a phosphoric acid source, water and ascorbic acid, wherein the ratio of the mole number of the lithium atoms to the mole number of the vanadium atoms and the ratio of the mole number of the phosphorus atoms to the mole number of the vanadium atoms are both from 0.95 to 1.2, and the ratio of the mole number of ascorbic acid to the mole number of the vanadium atoms is from 0.05 to 0.6, is heated under pressure, and the heated material is fired under pressure to obtain LiVOPO₄ having a very small average primary particle diameter and comprising an aggregate structure of which the shape of a secondary particle is close to a sphere and further having a high proportion of LiVOPO₄ with a β-type crystal structure, which has resulted in the completion of a second invention.

Specifically, the second invention provides a method for manufacturing an active material comprising: a hydrothermal synthesis step of heating under pressure, a mixture containing a lithium source, a vanadium source, a phosphoric acid source, water and ascorbic acid wherein the ratio of the mole number of the lithium atoms to the mole number of the vanadium atoms and the ratio of the mole number of the phosphorus atoms to the mole number of the vanadium atoms are both from 0.95 to 1.2, and the ratio of the mole number of ascorbic acid to the mole number of the vanadium atoms is from 0.05 to 0.6; and a firing step of heating the material produced at the hydrothermal synthesis step to obtain LiVOPO₄ having a β-type crystal structure.

The active material obtained by the method of manufacture according to the second invention has a small average primary particle diameter, comprises an aggregate structure of which the shape of a secondary particle is close to a sphere and further having a large proportion of LiVOPO₄ with a β-type crystal structure. A lithium ion secondary battery using such active material is capable of producing a large discharge capacity with a high rate characteristic. The reason for this phenomenon is not clear. However, the reason is assumed to be that: the active material obtained by the method of manufacture according to the invention ends up with a large discharge capacity because it is composed of LiVOPO₄ having a β-type crystal structure with a large discharge capacity as the principal component; the active material can be provided with a large discharge capacity even where the discharge current density is high because it has a very small average primary particle diameter and comprises an aggregate structure of which the shape of a secondary particle is close to a sphere thereby Li ion tends to diffuse isotropically with ease.

Further, the third invention provides an active material comprising as a principal component, LiVOPO₄ having a β-type crystal structure, the active material having an average primary particle diameter of from 100 to 350 nm and having an aggregate structure wherein the ratio of the length of the short axis to the length of the long axis in a secondary primary particle is from 0.80 to 1.

The active material comprises as a principal component, LiVOPO₄ having a β-type crystal structure, wherein its average primary particle diameter is a value within the above-mentioned range, its ratio of the length of the short axis to the length of the long axis in a secondary particle is a value within the above-mentioned range, and thus the secondary particle has a shape that is close to a sphere. This allows a large discharge capacity with a high rate characteristic to be obtained. This type of active material can be easily manufactured by the above-mentioned method.

Preferably, the active material according to the third invention has an average secondary particle diameter of from 1,500 to 8,000 nm. When the average secondary particle diameter of the active material is a value within the above-mentioned range, a large discharge capacity with a high rate characteristic can be easily obtained.

The fourth invention provides an electrode comprising a collector and an active material layer containing the active material mentioned above, wherein the active material layer is disposed on the collector. This allows a large discharge capacity with a high rate characteristic to be obtained.

The fifth invention provides a lithium secondary battery comprising the electrode mentioned above. This allows a lithium secondary battery having a large discharge capacity with a high rate characteristic to be obtained.

According to the present invention, there can be provided an active material capable of producing a large discharge capacity with a high rate characteristic, an electrode containing the active material, a lithium secondary battery comprising the electrode and a method for manufacturing the active material.

### BRIEF DESCRIPTION OF THE DRAWINGS

FIG. 1 is a schematic cross sectional view of an active material according to the present embodiment.

FIG. 2 is a schematic cross sectional view of a lithium ion secondary battery comprising an active material layer containing the active material according to the present embodiment.

FIG. 3 is a view showing an electron micrograph of the active material produced in Example B-1 when the magnification under observation has been set at 30,000-fold.

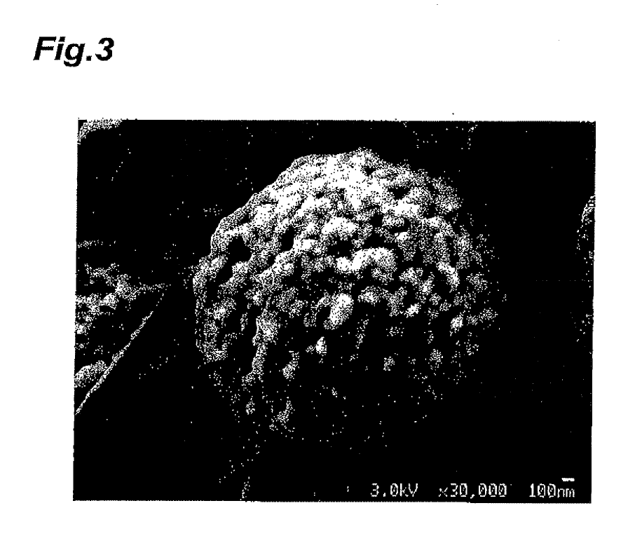

FIG. 4 is a view showing an electron micrograph of the active material produced in Example B-1 when the magnification under observation has been set at 50,000-fold.

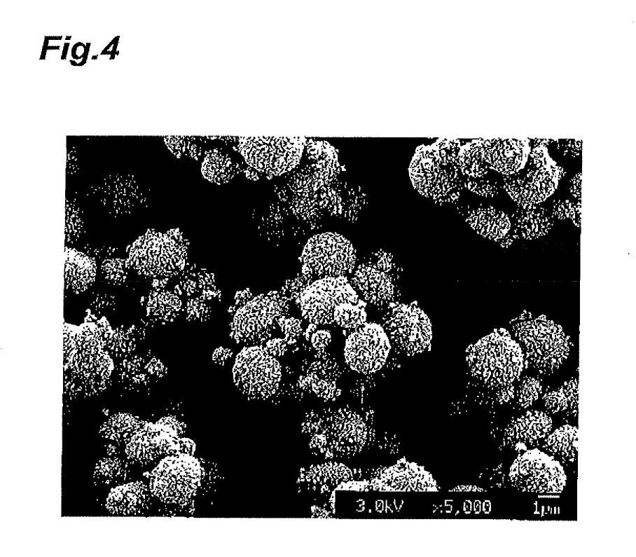

1-primary particle; 2-active material (secondary particle); 10,20-electrode; 12-positive electrode collector; 14-positive electrode active material layer; 18-separator; 22-negative electrode collector; 24-negative electrode active material layer; 30-laminate; 50-case; 52-metal foil; 54-polymer film; 60,62-lead; 100-lithium ion secondary battery.

### DESCRIPTION OF THE PREFERRED EMBODIMENTS

The method for manufacturing an active material according to an embodiment of the first invention comprises: a hydrothermal synthesis step of heating under pressure, a mixture containing a lithium source, a vanadium source, a phosphoric acid source, water and a water-soluble polymer having a weight average molecular weight of from 200 to 100,000,

wherein the ratio of the total mole number of repeating units of the whole water-soluble polymer to the mole number of the vanadium atoms is 0.02 to 1.0, to produce a precursor of LiVOPO₄ having a β-type crystal structure; and a firing step of heating the precursor of LiVOPO₄ having a β-type crystal structure to obtain LiVOPO₄ having a β-type crystal structure.

[Hydrothermal Synthesis Step]

The hydrothermal synthesis step according to the present embodiment is a step of heating under pressure, a mixture containing a lithium source, a vanadium source, a phosphoric acid source, water and a water-soluble polymer having a weight average molecular weight of from 200 to 100,000, wherein the ratio of the total mole number of repeating units of the whole water-soluble polymer to the mole number of the vanadium atoms is 0.02 to 1.0, to produce a precursor of LiVOPO₄ having a β-type crystal structure.

(Mixture)

Examples of the lithium source include lithium compounds, such as LiNO₃, Li₂CO₃, LiOH, LiCl, Li₂SO₄ and CH₃COOLi. Among these compounds, LiNO₃ and Li₂CO₃ are preferable. As the vanadium source, there may be mentioned vanadium compounds such as V₂O₅ and NH₄VO₃. Examples of the phosphoric acid source include PO₄-containing compounds such as H₃PO₄, NH₄H₂PO₄, (NH₄)₂HPO₄ and LiPO₄. Among these compounds, H₃PO₄ and (NH₄)₂HPO₄ are preferable.

The blending ratio of the lithium source, phosphoric acid source, and vanadium source may be adjusted so that the resulting composition can be represented by the compositional formula of LiVOPO₄, namely Li atom: V atom: P atom: O atom=1:1:1:5 (molar ratio).

The water-soluble polymer is a polymer that dissolves in water and is provided with polarity in the molecule. Particularly, among these, those which contain oxygen atoms in the molecules are preferable. However, the water-soluble polymers containing halogen atoms or sulfur atoms, or those capable of releasing metal ions into the mixture will not be preferable even if they posses polarity in their molecules, because there is a concern that they may corrode a device for hydrothermal synthesis or may remain in the mixture as impurities.

Preferably, the water-soluble polymer comprises at least one selected from the group consisting of polyethylene glycol, a copolymer of vinyl methyl ether/maleic acid anhydride, and polyvinylpyrrolidone. Among these, polyethylene glycol is particularly preferable from the standpoint of producing LiVOPO₄ having a β-type crystal structure in a high yield.

The weight average molecular weight of the water-soluble polymer is from 200 to 100,000. When polyethylene glycol is used, its weight average molecular weight is preferred to be from 400 to 50,000, and is particularly preferred to be from 400 to 4,000. Within the above-mentioned range, a high rate characteristic and a large discharge capacity can be obtained.

The content of the water-soluble polymer in the mixture containing a lithium source, a vanadium source, a phosphoric acid source, water and a water-soluble polymer is from 0.02 to 1.0 when it will be convened as the ratio of the total mole number of repeating units of the whole water-soluble polymer to the mole number of the vanadium atoms in the vanadium source. When the content of the water-soluble polymer in the mixture is a value within the above-mentioned range, the average primary particle diameter is small and the active material having a large proportion of LiVOPO₄ with a β-type crystal structure can be obtained. When the content of the water soluble polymer in the mixture is less than 0.02, the average primary particle diameter will increase. On the other hand, when it is greater than 1.0, it will be difficult to obtain LiVOPO₄ having a β-type crystal structure. Preferably, the content of the water-soluble polymer in the mixture is from 0.2 to 0.8 from the standpoint of obtaining an active material having a far smaller average primary particle diameter and having a large proportion of LiVOPO₄ with a β-type crystal structure.

As used herein, the term “average primary particle diameter” means a value of D50 that corresponds to a cumulative percentage of 50% in the particle size distribution based on the determined numbers of the primary particles of the obtained LiVOPO₄. The particle size distribution based on the numbers of primary particles can be determined by measuring the diameter of an equivalent circle for projected area derived from the projected area of the LiVOPO₄ primary particles that is based on the image observed under a high resolution scanning electron microscope and calculating from the cumulative percentage of it, for example. The diameter of the equivalent circle for projected area is expressed as a particle diameter by assuming a sphere having the same projected area as that of the particle and in terms of the diameter of said sphere (equivalent circle diameter).

As used herein, the “repeating unit” with respect to polyethylene glycol (PEG) specifically means that shown in formula (I) below; with respect to copolymer of vinyl methyl ether/maleic acid anhydride (VEMA), the repeating unit is shown in formula (II); and with respect to polyvinylpyrrolidone, the repeating unit is shown in formula (III).

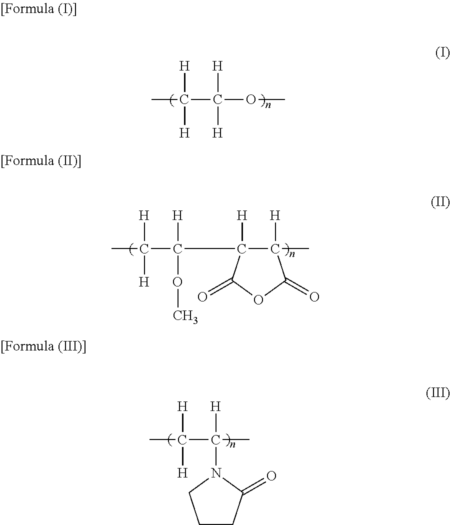

As used herein, the term “the total mole number of repeating units of the whole water-soluble polymer” specifically means the sum of (n₁+n₂+n₃+ . . . +nₘ) when the number of repeating units contained in the respective molecules is n₁, n₂, n₃, n₄, . . . or nₘ where the water-soluble polymers is present in the number of m.

As used herein, the water-soluble polymer has, preferably, an energy level of its Highest Occupied Molecular Orbital being lower than −9.6 ev. When the energy level of the highest Occupied Molecular Orbital is lower than −9.6 ev, it will be easy to obtain LiVOPO₄ having a β-type crystal structure. The energy level of the Highest Occupied Molecular Orbital of the water-soluble polymer can be determined by the calculation using MOPAC, for example. If such value is taken into consideration, it will be easy to select a suitable water-soluble polymer.

Further, a strong reductive substance such as ethylene diamine or hydrazine monohydrate may be added to the above-mentioned mixture. This allows LiVOPO₄ having a β-type crystal structure in the whole active material to be increased and a large discharge capacity with a high rate characteristic to be obtained.

Next, when the obtained active material is used to prepare an active material containing layer of an electrode, the surfaces of the active material are routinely made into contact with a conductive material such as a carbon substance to enhance conductivity in many cases. This method may involve mixing the active material with the conductive material after the active material has been manufactured to form the active material containing layer; however, carbon can be attached to the active material by adding the carbon substance to the mixture as a conductive material, for example.

When the conductive material, which is a carbon substance, is added to the mixture, there may be mentioned activated carbon, graphite, soft carbon, and hard carbon, for example. Among these substances, activated carbon is preferably used because it can easily disperse carbon particles in the mixture at the hydrothermal synthesis step. However, it is not necessary to mix the total amount of the conductive material into the mixture at the hydrothermal synthesis step; and it is preferred that at least a portion is mixed into the mixture at the hydrothermal synthesis step. Thereby, the amounts of binders can be decreased in the formation of an active material containing layer so that capacity density may increase.

The content of the conductive material, such as carbon particles, in the mixture at the hydrothermal synthesis step is preferably adjusted so that the ratio of C2/M, where the mole number of the carbon atoms that constitute the carbon particles is C2 and the mole number of the vanadium atoms is M, may satisfy 0.04≦C2/M≦4. When the content of the conductive material (the mole number of C2) is too low, the electron conductivity and capacity density of an electrode active material composed of the active material and the conductive material tend to lower. When the content of the conductive material is excessive, the weight of the active material occupying the electrode active material decreases relatively; and the capacity density of the electrode active material tends to decrease. If the content of the conductive material is set within the above-mentioned range, these tendencies can be suppressed.

The amount of water in the mixture is not particularly limited insofar as the hydrothermal synthesis is feasible; however, the proportions of materials other than water in the mixture are preferably 35% by mass or less.

In preparing the mixture, the order of charging starting materials is not particularly limited. For example, the starting materials of the above-mentioned mixture may be mixed at once. Alternatively, a vanadium compound may be first added to a mixture of water and a PO₄-containing compound, and then, a water-soluble polymer may be added, followed by the addition of a lithium compound. Preferably, the mixture is sufficiently blended to keep additives being dispersed adequately.

In the hydrothermal synthesis step, the above-mentioned mixture (lithium compound, vanadium compound, PO₄-containing compound, water, water-soluble polymer) is first charged into a reactor (such as autoclave) that has the function of heating and pressurizing its interior. In addition, the mixture may be preparing in the reactor.

The reactor is then hermitically closed and heated, while pressurizing the mixture, to allow for the progression of the hydrothermal reaction of the mixture. This will achieve the hydrothermal synthesis of a material containing the precursor of LiVOPO₄ having a β-type crystal structure.

The material containing the precursor of LiVOPO₄ having a β-type crystal structure that has been produced by hydrothermal synthesis normally precipitates as solid in the solution after the hydrothermal synthesis. It is thought that the precursor of LiVOPO₄ having a β-type crystal structure contained in the material exists as the form of a hydrate. Further, the solution after the hydrothermal synthesis is, for example, filtrated to collect solids and the collected solids are washed with water, acetone or the like. Then, drying will allow the precursor to be obtained in high purity.

In the hydrothermal synthesis step, the pressure loaded to the mixture is preferably set to from 0.1 to 30 MPa. When the pressure loaded to the mixture is too low, there is a tendency that the crystallinity of LiVOPO₄ having a β-type crystal structure to be finally obtained lowers and the capacity density of the active material decreases. When the pressure loaded to the mixture is too high, the reactor needs high pressure resistance and the manufacturing cost of the active material tends to increase. If the pressure loaded to the mixture material is set within the above-mentioned range, these tendencies can be suppressed.

Preferably, the temperature of the mixture at the hydrothermal synthesis step is set to from 120 to 300° C. When the temperature of the mixture is too low, there is a tendency that the crystallinity of LiVOPO₄ having a β-type crystal structure to be finally obtained lowers and the capacity density of the active material decreases. When the temperature of the mixture is too high, the reactor needs high heat resistance and the manufacturing cost of the active material tends to increase. If the temperature of the mixture is set within the above-mentioned range, these tendencies can be suppressed.

[Firing Step]

The firing step according to the present embodiment is a step at which the precursor of LiVOPO₄ having a β-type crystal structure is heated to produce LiVOPO₄ having a β-type crystal structure. It is thought that at this step, a phenomenon of impurities, which remained in the mixture after the hydrothermal synthesis step, being removed occurs and at the same time, the precursor of LiVOPO₄ having a β-type crystal structure is dehydrated to cause crystallization.

In the firing step above, the above-mentioned precursor is preferably heated at from 400 to 650° C. for 0.5 to 10 hr. When the heating time is too short, there is a tendency that the crystallinity of LiVOPO₄ having a β-type crystal structure to be finally obtained lowers and the capacity density of the active material decreases. On the other hand, when the heating time is too long, the particle growth of the active material progresses to increase the particle diameter; and as a result, there is a tendency that the diffusion of lithium in the active material slows down and the capacity density of the active material decreases. If the heating time is set within the above-mentioned range, these tendencies can be suppressed.

The atmosphere of the firing step is not particularly limited; however, it is preferably an air atmosphere to facilitate the removal of the water-soluble polymer. Besides, firing may be carried out in an inert atmosphere such as argon gas or nitrogen gas.

According to the method for manufacturing an active material comprising the hydrothermal synthesis step and the firing step as described above, the active material having a small average primary particle diameter and a large proportion of LiVOPO₄ with a β-type crystal structure can be obtained.

LiVOPO₄ having a β-type crystal structure contained in the active material is preferably 50% by mass or greater, and more preferably, 70% by mass or greater based on the total of LiVOPO₄ having aβ-type crystal structure and LiVOPO₄ having an α-type crystal structure. As used herein, the quantity of LiVOPO₄ having a β-type crystal structure or LiVOPO₄ having an α-type crystal structure in the particle can be determined by X-ray diffraction measurement, for example. Normally, the peak of LiVOPO₄ having a β-type crystal structure appears at 2θ=27.0 degrees, whereas the peak of LiVOPO₄ having an α-type crystal structure appears at 2θ=27.2 degrees. Further, the active material may contain minute amounts of unreacted starting components other than LiVOPO₄ having a β-type crystal structure and LiVOPO₄ having an α-type crystal structure.

As stated above, a preferred embodiment of the method for manufacturing an active material according to the first invention has been described in detail; however, the present invention should not be limited thereto.

The active material obtained by the method for manufacturing an active material according to the first invention can be used for an electrode material of an electrochemical element other than a lithium secondary battery. As such an electrochemical element, there may be mentioned a secondary battery other than a lithium secondary battery, including a metal lithium secondary battery (where an electrode containing the active material of the invention is used as cathode and metal lithium is used as anode) and an electrochemical capacitor, including a lithium capacitor. These electrochemical elements can be used in the utilities of a micromachine of the self-run type, a power source such as an IC card and a dispersed power source disposed on or within a print board.

Preferred embodiments of the second to the fifth inventions will be described in detail by referring to the drawings hereafter. Of note is that the proportions or dimensions in the respective drawings do not necessarily match the real proportions or dimensions.

<Method for Manufacturing Active Material>

A preferred embodiment of the method for manufacturing an active material according the second invention will be described.

### [Hydrothermal Synthesis Step]

The hydrothermal synthesis step according to the present embodiment is a step of heating under pressure, a mixture containing a lithium source, a vanadium source, a phosphoric acid source, water and ascorbic acid, wherein the ratio of the mole number of the lithium atoms to the mole number of the vanadium atoms and the ratio of the mole number of the phosphorus atoms to the mole number of the vanadium atoms are both from 0.95 to 1.2, and the ratio of the mole number of ascorbic acid to the mole number of the vanadium atoms is from 0.05 to 0.6.

(Mixture)

Examples of the lithium source include lithium compounds such as LiNO₃, Li₂CO₃, LiOH, LiCl, Li₂SO₄ and CH₃COOLi. Among these compounds, Li NO₃ and Li₂CO₃ are preferable. As the vanadium source, there may be mentioned vanadium compounds such as V₂O₅ and NH₄VO₃. As the phosphoric acid source, there may be mentioned PO₄-containing compounds such as H₃PO₄, NH₄H₂PO₄, (NH₄)₂HPO₄ and LiPO₄. Among these compounds, H₃PO₄ and (NH₄)₂HPO₄ are preferable.

The lithium source, vanadium source and phosphoric acid source are blended so that the ratio of the mole number of the lithium atoms to the mole number of the vanadium atoms is 0.95 to 1.2 and the ratio of mole number of the phosphorus atoms to the mole number of the vanadium atoms is 0.95 to 1.2. When at least one of the blending ratios of the lithium atoms and phosphorous atoms is less than 0.95, the discharge capacity of the active material to be obtained tends to decrease and the rate characteristic also tends to lower. When at least one of the blending ratios of the lithium atoms and phosphorous atoms is greater than 1.2, the discharge capacity of the active material to be obtained tends to decrease.

Ascorbic acid is blended to the mixture so that the ratio of the mole number of ascorbic acid to the mole number of the vanadium atoms is from 0.05 to 0.6. By blending ascorbic acid, it will be possible to produce an active material principally containing LiVOPO₄ having a β-type crystal structure and it will be likely to be able to make the average primary and secondary particle diameters small. When ascorbic acid is blended at a ratio of from 0.05 to 0.6 relative to the mole number of the vanadium atoms, the shape of the active material will be very close to a sphere and a large discharge capacity with a high rate characteristic can be obtained. This finding has never been gained thus far, and these effects are remarkable as compared to the prior art.

Next, when the obtained active material is used to prepare an active material containing layer of an electrode, the surfaces of the active material are routinely made into contact with a conductive material such as a carbon substance to enhance conductivity in many cases. This method may involve mixing the active material with the conductive material after the active material has been manufactured to form an active material containing layer; however, carbon can be attached to the active material by adding the carbon substance as a conductive material to the mixture that is raw material of hydrothermal synthesis.

As the conductive material, which is a carbon substance, to be added to the mixture, there may be mentioned activated carbon, graphite, soft carbon, and hard carbon, for example. Among these substances, activated carbon is preferably used because it can easily disperse carbon particles in the mixture at the hydrothermal synthesis step. However, it is not necessary to mix the total amount of the conductive material into the mixture at the hydrothermal synthesis step; and it is preferred that at least a portion is mixed into the mixture at the hydrothermal synthesis step. Thereby, the amounts of binders can be decreased in the formation of an active material containing layer so that capacity density may increase.

The content of the conductive material, such as carbon particles, in the mixture at the hydrothermal synthesis step is preferably adjusted so that the ratio of C2/M, where the mole number of the carbon atoms that constitute the carbon particles is C2 and the mole number of the vanadium atoms contained in the vanadium compound is M, may satisfy 0.04≦C2≦M≦4. When the content of the conductive material (the mole number of C2) is too low, the electron conductivity and capacity density of an electrode active material composed of the active material and the conductive material tend to lower. When the content of the conductive material is excessive, the weight of the active material occupying the electrode active material decreases relatively; and the capacity density of the electrode active material tends to decrease. If the content of the conductive material is set within the above-mentioned range, these tendencies can be suppressed.

The amount of water in the mixture is not particularly limited insofar as the hydrothermal synthesis is feasible; however, the proportions of materials other than water in the mixture are preferably 35% by mass or less.

In preparing the mixture, the order of charging starting materials is not particularly limited. For example, the starting materials of the above-mentioned mixture may be mixed at once. Alternatively, a vanadium compound may be first added to a mixture of water and a PO₄-containing compound, and then, ascorbic acid may be added, followed by the addition of a lithium compound. Preferably, the mixture is sufficiently blended to keep additives being dispersed adequately.

In the hydrothermal synthesis step, the above-mentioned mixture (lithium compound, vanadium compound, PO₄-containing compound, water, ascorbic acid and others) is first charged into a reactor (such as autoclave) that has the function of heating and pressurizing its interior. In addition, the mixture may be prepared in the reactor.

The reactor is then hermetically closed and heated, while pressurizing the mixture, to allow for the progression of the hydrothermal reaction of the mixture. This achieve the hydrothermal synthesis of a material containing the precursor of LiVOPO₄ having a β-type crystal structure.

The material containing the precursor of LiVOPO₄ having a β-type crystal structure that has been produced by hydrothermal synthesis normally precipitates as solid in the solution after the hydrothermal synthesis. It is thought that the precursor of LiVOPO₄ having a β-type crystal structure contained in the material exists as the form of a hydrate. Further, the solution after the hydrothermal synthesis is, for example, filtrated to collect solids and the collected solids are washed with water, acetone or the like. Then, drying will allow the precursor to be obtained in high purity.

In the hydrothermal synthesis step, the pressure loaded to the mixture is preferably set to from 0.1 to 30 MPa. When the pressure loaded to the mixture is too low, there is a tendency that the crystallinity of LiVOPO₄ having a β-type crystal structure to be finally obtained lowers and the capacity density of the active material decreases. When the pressure loaded to the mixture is too high, the reactor needs high pressure resistance and the manufacturing cost of the active material tends to increase. If the pressure located to the mixture material is set within the above-mentioned range, these tendencies can be suppressed.

The temperature of the mixture in the hydrothermal synthesis step is set preferably to from 200 to 300° C. and, more preferably, to from 210 to 250° C. from the standpoint of improving the discharge capacity and rate characteristic of the active material to be obtained. When the temperature of the mixture is too low, there is a tendency that the crystallinity of LiVOPO₄ having a β-type crystal structure to be finally obtained lowers and the capacity density of the active material decreases. When the temperature of the mixture is too high, the reactor needs high pressure resistance and the manufacturing cost of the active material tends to increase. If the temperature of the mixture is set within the above-mentioned, these tendencies can be suppressed.

[Firing Step]

The firing step according to the present embodiment is a step at which the material obtained by hydrothermal synthesis, namely the precursor of LiVOPO₄ having a β-type crystal structure, is heated to produce LiVOPO₄ having a β-type crystal structure. It is thought that at this step, a phenomenon of impurities, which remained in the mixture after the hydrothermal synthesis step, being removed occurs, and at the same time, the precursor of LiVOPO₄ having a β-type crystal structure is dehydrated to cause crystallization.

In the firing step above, the aforementioned precursor is preferably heated at from 400 to 600° C. When the heating temperature is too low, there is a tendency that the crystallinity of LiVOPO₄ having a β-type crystal structure to be finally obtained lowers and the capacity density of the active material decreases. On the other hand, when the heating temperature is too high, the particle growth of the active material progresses to increase the particle diameters (primary and secondary particle diameters); and as a result, there is a tendency that the diffusion of lithium in the active material slows down and the capacity density of the active material decreases. If the heating temperature is set within the above-mentioned range, these tendencies can be suppressed. The heating time is not particularly limited; however, it is preferably set at 3 to 6 hr.

The atmosphere of the firing step is not particularly limited; however, it is preferably an air atmosphere to facilitate the removal of ascorbic acid. Besides, firing may be carried out in an inert atmosphere such as argon gas or nitrogen gas.

According to the method for manufacturing an active material comprising the hydrothermal synthesis step and the firing step as described above, a mixture containing a lithium source, a vanadium source, a phosphoric acid source, water and ascorbic acid, wherein the ratio of the mole number of the lithium atoms to the mole number of the vanadium atoms and the ratio of the mole number of the phosphorus atoms to the mole number of the vanadium atoms are both from 0.95 to 1.2, and the ratio of the mole number of ascorbic acid to the mole number of the vanadium atoms is from 0.05 to 0.6 is heated under pressure, and the thus-obtained precursor is fired. Thus, there can be obtained LiVOPO₄ having a very small average primary particle diameter and comprising an aggregate structure of which the shape of a secondary particle is close to a sphere and further having a large proportion of the LiVOPO₄ with a β-type crystal structure. Further, a lithium ion secondary battery using such active material is capable of producing a large discharge capacity with a high rate characteristic.

<Active Material>

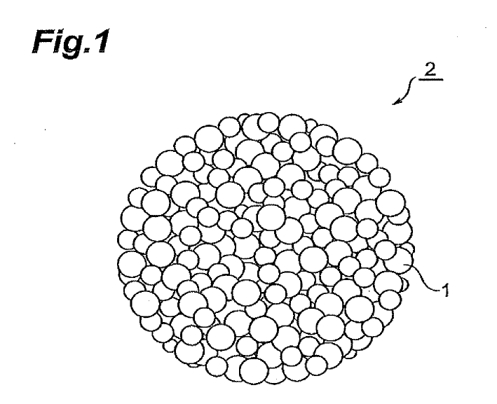

A preferred embodiment of an active material according to the third invention will be described next. FIG. 1 is a schematic cross sectional view of an active material 2 according to the present embodiment. The active material 2 according to the present embodiment forms a secondary particle comprising an aggregate of primary particles.

The active material 2 has an average primary size of from 100 to 350 nm. As defined in the present invention, the term “average primary particle diameter of active material” means a value of D50 that corresponds to a cumulative percentage of 50% in the particle size distribution based on the determined numbers of the primary particles 1 of the active material 2. Specifically, the particle size distribution based on the numbers of the primary particles 1 of the active material 2 can be determined by measuring the diameter of an equivalent circle for projected area derived from the projected area of the primary particles 1 of the active material 2 that is based on the image observed under a high resolution scanning electron microscope and calculating from the cumulative percentage of it. The diameter of the equivalent circle for projected area is expressed as a particle diameter (a particle diameter of primary particle 1 of the active material 2) by assuming a sphere having the same projected area as that of the particle (primary particle 1 of the active material 2) and in terms of the diameter of said sphere (equivalent circle diameter). In addition, similarly to the above-defined average primary particle diameter, the term “average secondary particle diameter of active material” described later means a value of D50 that corresponds to a cumulative percentage of 50% in the particle size distribution based on the determined numbers of the active material 2, which is a aggregate of particles (which also corresponds to the secondary particle of the active material according to the invention).

The ratio of the length of the short axis to the length of the long axis of the active material 2 is from 0.80 to 1. As defined in the present invention, the term “the length of the long axis of the active material” for a secondary particle means the longest length in the image observed under a high resolution scanning electron microscope; and the term “the length of the short axis of the active material” means the length of a segment of a bisector that is perpendicular to the long axis. When the ratio of the length of the short axis to the length of the long axis is 1, the shape of the active material is a sphere. The ratio of being from 0.80 to 1 means that the shape of the secondary particle of the obtained active material is a sphere or very close to a sphere. Particularly, the material having a ratio of from 0.81 to 0.93 may be easily manufactured.

The active material 2 comprises LiVOPO₄ having a β-type crystal structure as the primary component. As used herein, the term “LiVOPO₄ having a β-type crystal structure as the primary component” means that the active material 2 contains 80% by mass or greater of LiVOPO₄ having a β-type crystal structure based on the total of LiVOPO₄ having a β-type crystal structure and LiVOPO₄ having an α-type crystal structure. As used herein, the quantity of LiVOPO₄ having a β-type crystal structure or LiVOPO₄ having an α-type crystal structure in the particle can be determined by X-ray diffraction measurement, for example. Normally, the peak of LiVOPO₄ having a β-type crystal structure appears at 2θ=27.0 degrees, whereas the peak of LiVOPO₄ having an α-type crystal structure appears at 2θ=27.2 degrees. Further, the active material may contain minute amounts of unreacted starting components and others except LiVOPO₄ having a β-type crystal structure and LiVOPO₄ having an α-type crystal structure.

Such active material is produced easily according to the above-mentioned manufacturing method of the second invention. This active material is capable of producing a large discharge capacity with a high rate characteristic. The reason for this phenomenon is not clear. However, the reason is assumed to be that: the active material ends up with a large discharge capacity because it is composed of LiVOPO₄ having a β-type crystal structure with a large discharge capacity as the principal component; the active material can be provided with a large discharge capacity even where the discharge current density is high because it has a very small average primary particle diameter and comprises an aggregate structure of which the shape of a secondary particle is very close to a sphere thereby Li ion tends to diffuse isotropically with ease. Moreover, as mentioned above, the active material is an aggregate structure or a porous structure; therefore, it has a capability of being impregnated with an electrolyte.

Preferably, the average particle diameter (average secondary particle) of the active material 2 is from 1,500 to 8,000 nm. Such active material is capable of producing a large discharge capacity with a high rate characteristic.

Lithium Ion Secondary Battery>

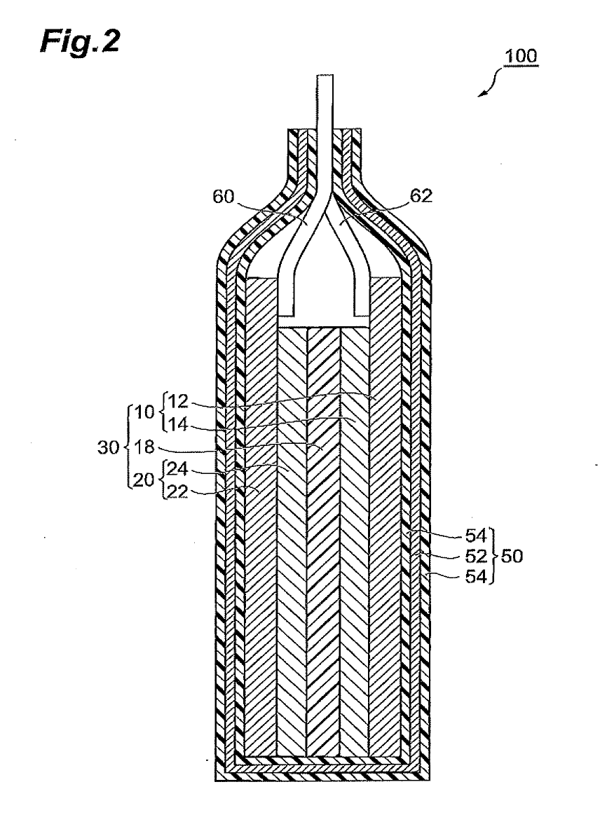

Subsequently, the lithium ion secondary battery using the above-mentioned active material as a positive electrode will be briefly described by referring to FIG. 2.

A lithium ion secondary battery 100 principally comprises a laminate 30, a case 50 for accommodating the laminate 30 in a sealed state and a pair of electrodes 60, 62 that are connected to the laminate 30.

The laminate 30 comprises a pair of positive electrode 10 and a negative electrode 20 that are disposed opposingly by sandwiching a separator 18. The positive electrode 10 is provided with a positive electrode collector 12 and a positive electrode active material layer 14 thereon. The negative electrode 20 is provided with a negative electrode collector 22 and a negative electrode active material layer 24 thereon. The positive electrode active material layer 14 and the negative electrode active material layer 24 are, respectively, in contact with both sides of the separator 18. Leads 60, 62 are connected to the end parts of the positive electrode collector 12 and the negative electrode collector 22, respectively; and the end parts of the leads 60, 62 extends to the outside of the case 50.

(Positive Electrode)

As FIG. 2 shows, the positive electrode 10 comprises the positive electrode collector 12 of a sheet form (or film form) and the positive electrode active material layer 14 formed on the positive electrode collector 12.

The positive electrode collector 12 may be any conductive sheet member, and metal thin sheets such as aluminum, copper and nickel foils can be used. The positive electrode active material layer 14 principally comprises the above-mentioned active material 2 and binders. Further, the positive electrode active material layer 14 may comprises conductive auxiliaries.

The binder binds the active materials together as well as binds the active material to the positive electrode collector 12.

The materials of the binder may only be capable of the above-mentioned binding and examples of the materials of the binder include fluororesins such as polyvinylidene fluoride (PVDF), polytetrafluoroethylene (PTFE), tetrafluoroethylene/hexafluoropropylene copolymer (FEP), tetrafluoroethylene/perfluoroalkylvinylether copolymer (PFA), ethylene/tetrafluoroethylene copolymer (ETFE), polychlorotrifluoroethylene (PCTFE), ethylene/chlorotrifluoroethylene copolymer (ECTFE) and polyvinyl fluoride (PVF).

In addition to the above-mentioned ones, examples of the binder include vinylidene fluoride based fluororubbers, such as vinylidene fluoride/hexafluoropropylene based fluororubber (VDF/HFP based fluororubber), vinylidene fluoride/hexafluoropropylene/tetrafluoroethylene based fluororubber (VDF/HFP/TFE based fluororubber), vinylidene fluoride/pentafluoropropylene based fluororubber (VDF/PFP based fluororubber), vinylidene fluoride/pentafluoropropylene/tetrafluoro ethylene based fluororubber (VDF/PFP/TFE based fluororubber), vinylidene fluoride/perfluoromethylvinylether/tetrafluoroethylene based fluororubber (VDF/PFMVE/TFE based fluororubber), and vinylidene fluoride/chlorotrifluoroethylene based fluororubber (VDF/CTFE based fluororubber).

In addition to the above-mentioned ones, examples of the binder include polyethylene, polypropylene, polyethyleneterephtalate, aromatic polyamides, cellulose, styrene/butadiene rubber, isoprene rubber, butadiene rubber, and ethylene/propylene rubber. There can also be used polymers of the thermoplastic elastomer type such as a styrene/butadiene/styrene block copolymer, a hydrogenated product thereof, a styrene/ethylene/butadiene/styrene copolymer, styrene/isoprene/styrene block copolymer and hydrogenated products thereof. Further, there can be used a syndiotactic 1,2-polybutadiene/ethylene/vinyl acetate copolymer, a propylene/α-olefin (having a carbon number of 2-12) copolymer and the like.

Also, conductive polymers that are electron-conductive or ion-conductive polymers are may be used as binders. The examples of the electron-conductive polymer include polyacetylene. In this case, the binder functions as conductive auxiliary particles and thus, the addition of conductive auxiliaries is unnecessary.

As the examples of the ion-conductive polymer include those having conductivity of ion such as lithium ion. Specifically, there may be mentioned complexes between the monomer of a polymer, including a polyether based polymer such as polyethylene oxide and polypropylene oxide, a cross-linked polymer of a polyether-based polymer, polyepichlorohydrin, polyphosphazene, polysiloxane, polyvinylpyrrolidone, polyvinylidene carbonate and polyacrylonitrile, and a lithium salt such as LiClO₄, LiBF₄, LiPF₆, LiAsF₆, LiCl, LiBr, Li(CF₃SO₂)₂N or LiN(C₂F₅SO₂)₂ or an alkaline metal salt composed principally of lithium. The initiators for use in complexation include photoinitiators and thermal initiators, both of which are suited to the above-mentioned monomers.

Preferably, the content of the binder included in the positive electrode active material layer 14 is from 0.5 to 6% by mass based on the mass of the active material layer: When the content of the binder is less than 0.5% by mass, there is a great tendency that a firm active material layer cannot be formed, because the amount of binder is too small. On the other hand, when the content of the binder exceeds 6% by mass, there is a great tendency that obtaining sufficient volume energy density meets difficulties, because the amount of binder that does not contribute to electric capacity becomes larger. In this case, particularly if the electron conductivity of the binder is low, there is a great tendency that sufficient electric capacity cannot be obtained, because the electric resistance of the active material layer increases.

The conductive auxiliaries, for example, include carbon black, carbon substances, metallic fine powders such as copper, nickel, stainless and iron, a mixture of the carbon substance and the metallic fine powder and conductive oxides such as ITO.

(Method for Manufacturing Positive Electrode)

A slurry is prepared by adding the aforementioned active material, a binder and a conductive auxiliary in such an amount as necessary to a solvent. As solvent, there can be used N-methyl-2-pyrrolidone and N,N-dimethylformamide, for example. The slurry containing the active material, the binder and others may then be applied to the surface of the positive electrode collector 12 and dried.

(Negative Electrode)

The negative electrode 20 comprises a negative electrode collector 22 of a sheet form and a negative electrode active material layer 24 formed on the negative electrode collector 22. As for the negative electrode collector 22, binder and conductive auxiliaries, the same ones for the positive electrode may be used. Further, the negative electrode active material is not particularly limited; and negative electrode active materials for batteries that are known in the art can be used. Examples of the negative electrode active material include particles containing carbon substances such as graphite capable of occluding and releasing lithium ions (intercalation/deintercalation or doping/undoping), carbon to be hardly graphitized, carbon to be easily graphitized and carbon fired at a low temperature, metals that can be combined with lithium such as Al, Si and Sn, amorphous compounds principally composed of oxides such as SiO₂ and SnO₂, and lithium titanate (Li₄Ti₅O₁₂).

(Electrolyte)

The electrolyte solution is included within the positive electrode active material layer 14, negative electrode active material layer 24 and separator 18. The electrolyte solution is not particularly limited and, for example, an electrolyte solution containing a lithium salt, which is an electrolyte aqueous solution or an electrolyte solution using an organic solvent, can be used in the present embodiment. However, since the electrolyte aqueous solution has a low decomposition voltage electrochemically which limits its withstand voltage at charging to a low value, the electrolyte solution using an organic solvent (non-aqueous electrolyte solution) is preferable. As the electrolyte solution, there may be preferably used a solution where a lithium salt is dissolved in a non-aqueous solvent (or organic solvent). Examples of the lithium salt which can be used include the salts of LiPF₆, LiClO₄, LiBF₄, LiAsF₆, LiCF₃SO₃, LiCF₅, LiCF₂SO₃, Li(CF₃SO₂)₃, LiN(CF₃SO₂)₂, LiN(CF₃CF₂SO₂)₂, LiN(CF₃SO₂)(C₄F₉SO₂), LiN(CF₃CF₂CO₂)₂, and LiBOB. Further, these salts may be used alone or in combinations of two or more.

Preferably, the organic solvents include propylene carbonate, ethylene carbonate and diethyl carbonate, for example. These may be used alone or in combinations of two or more at any proportions.

Further, in the present embodiment the electrolyte solution may be an electrolyte in a gel form obtained by addition of a gelling agent, other than in a liquid form. The inclusion of a solid electrolyte, an electrolyte consisting of a solid polymer electrolyte or ion-conductive inorganic material, may also be an alternative to the electrolyte solution.

The separator 18 is a porous body that is electrically insulating. Specifically, there may be mentioned a lamina or laminate of films composed of polyethylene, polypropylene or polyolefin, an elongated film of a mixture of the above-mentioned resins, and a nonwoven fabric composed of at least one selected from the group consisting of cellulose, a polyester and polypropylene.

The case 50 seals the laminate 30 and the electrolyte in its interior. The case 50 is not particularly limited insofar as it can prevent the electrolyte from leaking to the outside as well as can prevent moisture or others from infiltrating from the outside into the inside of the electrochemical device 100. As FIG. 2 shows, there may be utilized a metal laminate film formed by coating a metal foil 52 with a polymer films 54 at both sides thereof. For example, an aluminum foil may be utilized as the metal foil 52 and films of polypropylene may be utilized as the polymer films 54. Specifically, polymers having a high melting point such as polyethylene terephthalate (PET) and polyamides are preferable as the material for the outer polymer film 54; and polyethylene, polypropylene and the like are preferable as the material for the inner polymer film 54.

The leads 60, 62 are formed of a conductive material such as aluminum.

According to a known method, the leads 60, 62 are welded to the positive electrode collector 12 and to the negative electrode collector 22, respectively; they are, together with the electrolyte, inserted into the case 50 in such a state that the separator 18 is sandwiched between the positive electrode active material layer 14 of the positive electrode 10 and the negative electrode active material layer 24 of the negative electrode 20; and the inlet of the ease 50 is then sealed.

As stated above, the method for manufacturing particles of an active material in accordance with the second to the fifth inventions, the active material obtained thereby, the electrodes containing said active materials, the lithium ion secondary battery comprising said electrodes have been described in detail with respect to a preferred embodiment. Nevertheless, the present invention is not to be limited to the above-mentioned embodiment.

Specifically, the active material obtained can also be used for an electrode material of an electrochemical element other than a lithium secondary battery. As such a electrochemical element, there may be mentioned a secondary battery other than a lithium secondary battery, including a metallic lithium secondary battery (where an electrode containing the active material of the invention is used as cathode and metallic lithium is used as anode) and an electrochemical capacitor, including a lithium capacitor. These electrochemical elements can be used in the utilities of a micromachine of the self-run type, a power source such as an IC card and a dispersed power source disposed on or within a print board.

Hereafter, the present invention will be described in more detail by referring to the Examples and Comparative Examples; however, the invention is not to be limited to the following examples.

### Example A-1

### Hydrothermal Synthesis Step

To a 500 ml Erlenmeyer flask, 23.06 g (0.20 mol) of H₃PO₄ (product of NACALAI TESQUE. INC. with a purity of 85%) and 180 g of distilled water (product of NACALAI TESQUE. INC. for use in HPLC) were charged and agitated with a magnetic stirrer. Subsequently, 18.38 g (0.10 mol) of V₂O₅ (product of NACALAI TESQUE. INC. with a purity of 99%) was added to the mixture and agitation continued for about 2.5 hr. Polyethylene glycol having a weight average molecular weight of 400 was next added dropwise to the above mixture. Specifically, 0.060 g (0.00015 mol) of polyethylene glycol (product of NACALAI TESQUE. INC) was added dropwise so that the ratio of the total mole number of repeating units of the whole polyethylene glycol molecule to the mole number of the vanadium atoms was 0.02. Subsequently, 8.48 g (0.20 mol) of LiOH.H₂O (product of NACALAI TESQUE. INC. with a purity of 99%) was added to the mixture over a period of about 10 min. After 20 g of distilled water had been further added to the resulting paste substance, 250.96 g of the substance in the flask was transferred to a 0.5 L cylindrical container made of glass for autoclave. When the pH of the substance in the container was measured, it was found to be 4. The container was hermetically closed. The heater was switched on and the temperature was held at 160° for 48 hr to carry our hydrothermal synthesis.

After the heater had been switched off, cooling by standing was carried out over about 2 hr to produce a substance containing dark brown precipitates and colorless transparent supernatant. When the pH of this substance was measured, it was found to be 3.5. After removal of the supernatant, about 200 ml of distilled water was added to the substance and the precipitates within the container were washed under agitation. Then, suction filtration was conducted. After having twice repeated washing as described above, about 200 ml of acetone was added and washed the precipitates similarly to water-washing. After filtration, the substance was transferred to a stainless petri dish, and vacuum drying was carried out at room temperature for 15.5 hr to produce 30.95 g of dark brown solid. The yield was 94.0% when converted as LiVOPO₄.

(Firing Step)

The dark brown solid obtained in the hydrothermal synthesis step, 3.00 g, was placed in an alumina crucible, temperature was raised from room temperature to 600° C. over 60 min in an air atmosphere, and the solid was heat-treated at 600° C. for 4 hr to yield a powder.

(Calculation of the Energy Level of the Highest Occupied Molecular Orbital (HOMO) for Water-Soluble Polymer)

The energy level of the Highest Occupied. Molecular Orbital (HOMO) for polyethylene glycol having a weight average molecular weight of 400 was calculated using MOPAC6 to be −10.5 ev.

(Measurement of β Ratio)

With respect to the active material according to Example A-1, the ratio (β ratio) of the β-type crystal structure to the total of LiVOPO₄ having a β-type crystal structure and LiVOPO₄ having an α-type crystal structure was determined from the results of powder X-ray diffraction (XRD). The β ratio of the active material according to Example A-1 was 86%.

(Measurement of Particle Size Distribution Based on Numbers and Average Primary Particle Diameter)

The particle size distribution of the active material according to Example A-1 was calculated in terms of the cumulative percentage of the diameter of an equivalent circle for projected area derived from the projected area of the active material that is based on the image observed under a high resolution scanning electron microscope. The average primary particle diameter (D50) of the active material was calculated in accordance with the calculated particle size distribution based numbers of the active material. The average primary particle diameter (D50) of the active material was 910 nm

(Measurement of Discharge Capacity)

A slurry was prepared by dispersing a mixture of the active material according to Example A-1, polyvinylidene fluoride (PVDF) as binder and acetylene black in N-methyl-2-pyrrolidone (NMF) as solvent. The slurry was prepared so that the weight ratio among the active material, acetylene black and PVDF was 84:8:8. This slurry was applied to an aluminum foil as a collector, and after drying, it was rolled to produce an electrode (positive electrode) on which an active material layer containing the active material according to Example A-1 had been formed.

Next, the obtained electrode and a lithium foil as an opposite electrode were laminated such that a separator comprising a polyethylene microporous membrane was interposed therebetween, to produce a laminate (element assembly). This laminate was placed in a laminate pack of aluminum, and after a 1 M solution of LiPF₆ as electrolyte had been infused to the laminate pack of aluminum, it was sealed under vacuum to prepare an evaluation cell according to Example A-1.

The evaluation cell according to Example A-1 was used to measure a discharge capacity (unit: mAh/g) at a discharge rate of 0.01 C (the current value at which the constant current discharging at 25° C. completes in 100 hr). The discharge capacity at 0.01 C was 142 mAh/g. The discharge capacity at a discharge rate (unit: mAh/g) of 0.1 C (the current value at which the constant current discharging at 25° C. completes in 10 hr) was measured. The discharge capacity at 0.1 C was 98 mAh/g.

(Evaluation of Rate Characteristic)

The percentage of the discharge capacity at 0.1 C relative to the discharge capacity at 0.01 C was calculated and evaluated as the rate characteristic. The rate characteristic of the evaluation cell according to Example A-1 is 69.0%.

### Examples A-2 to A-14 and Comparative Examples A-1 to A-5

Similarly to Example A-1, active materials according to Examples A-2 to A-14 and Comparative Examples A-1 to A-5 were obtained, except that the type and weight average molecular weight of the water-soluble polymer to be added to the mixture in the hydrothermal synthesis step, the content of the water-soluble polymer, the temperatures of the hydrothermal synthesis step and the firing atmosphere at the firing step were changed as shown in Tables 1, 2 below. The ratio (β ratio) of the β-type crystal structure to the total of LiVOPO₄ having a β-type crystal structure and LiVOPO₄ having an α-type crystal structure in the obtained active material, the average primary particle diameter (D50) of the active material, as well as the discharge capacity and rate characteristic of the evaluation cell using the active material are shown in Tables 3 and 4. In Example A-14, after addition of V₂O₅, 2.55 g (0.05 mol) of hydrazine monohydrate was added dropwise to the mixture under vigorous agitation. After the dropwise addition of hydrazine monohydrate, agitation continued for about 60 min (addition of a reducing agent). Then, polyethylene glycol having a weight average molecular weight of 400 was dropwise added to the mixture and the final mixture was prepared according to the same procedure as that in Example A-1.

TABLE 1

| | | | Added amount | | Hydrothermal | |
|---|---|---|---|---|---|---|
| | | | (mole number | | synthesis | Heat |
| | Type of | Molecular | per unit/V | HOMO | temperature | treatment |
| | polymer | weight | mol number | (eV) | (° C.) | conditions |
| Example A-1 | PEG | 400 | 0.02 | −10.5 | 160 | Air |
| | | | | | | 600° C. |
| | | | | | | 4 hr |
| Example A-2 | PEG | 400 | 0.2 | −10.5 | 160 | Air |
| | | | | | | 600° C. |
| | | | | | | 4 hr |
| Example A-3 | PEG | 400 | 0.4 | −10.5 | 160 | Air |
| | | | | | | 600° C. |
| | | | | | | 4 hr |
| Example A-4 | PEG | 400 | 0.8 | −10.5 | 160 | Air |
| | | | | | | 600° C. |
| | | | | | | 4 hr |
| Example A-5 | PEG | 400 | 1 | −10.5 | 160 | Air |
| | | | | | | 600° C. |
| | | | | | | 4 hr |
| Example A-6 | PEG | 4,000 | 0.2 | −10.5 | 160 | Air |
| | | | | | | 600° C. |
| | | | | | | 4 hr |
| Example A-7 | PEG | 400 | 0.2 | −10.5 | 160 | Argon |
| | | | | | | 600° C. |
| | | | | | | 4 hr |
| Example A-8 | PEG | 4,000 | 0.2 | −10.5 | 190 | Air |
| | | | | | | 600° C. |
| | | | | | | 4 hr |
| Example A-9 | PEG | 50,000 | 0.2 | −10.5 | 160 | Air |
| | | | | | | 600° C. |
| | | | | | | 4 hr |
| Example A-10 | PEG | 80,000 | 0.2 | −10.5 | 160 | Air |
| | | | | | | 600° C. |
| | | | | | | 4 hr |
| Example A-11 | PEG | 300 | 0.2 | −10.5 | 160 | Air |
| | | | | | | 600° C. |
| | | | | | | 4 hr |
| Example A-12 | VEMA | 50,000 | 0.05 | −11.3 | 160 | Air |
| | | | | | | 600° C. |
| | | | | | | 4 hr |
| Example A-13 | PVP | 34,000 | 0.3 | −10.9 | 160 | Air |
| | | | | | | 600° C. |
| | | | | | | 4 hr |
| Example A-14* | PEG | 400 | 0.2 | −10.5 | 250 | Air |
| | | | | | | 600° C. |
| | | | | | | 4 hr |

*In Example A-14, reducing agent (hydrazine monohydrate) was added to the mixture.

TABLE 2

| | | | Added amount | | Hydrothermal | |
|---|---|---|---|---|---|---|
| | | | (mole number | | synthesis | Heat |
| | Type of | Molecular | per unit/V | HOMO | temperature | treatment |
| | polymer | weight | mol number | (eV) | (° C.) | conditions |
| Comparative | None | — | 0 | — | 160 | Air |
| Example A-1 | | | | | | 600° C. |
| | | | | | | 4 hr |
| Comparative | PEG | 400 | 1.5 | −10.5 | 160 | Air |
| Example A-2 | | | | | | 600° C. |
| | | | | | | 4 hr |
| Comparative | PEG | 400 | 0.01 | −10.5 | 160 | Air |
| Example A-3 | | | | | | 600° C. |
| | | | | | | 4 hr |
| Comparative | Ammonia | — | 1.2 | −9.6 | 160 | Air |
| Example A-4 | | | | | | 600° C. |
| | | | | | | 4 hr |
| Comparative | PEG | 150 | 0.2 | −10.5 | 160 | Air |
| Example A-5 | | | | | | 600° C. |
| | | | | | | 4 hr |

TABLE 3

| | | | | | Discharge | Discharge | Rate |
|---|---|---|---|---|---|---|---|
| | pH | pH | | | capacity | capacity | characteristic |
| | before | after | β ratio | D50 | (mAh/g) | (mAh/g) | (%) (0.1 C/ |
| | reaction | reaction | (%) | (μm) | 0.01 C | 0.1 C | 0.01 C) |
| Example A-1 | 4 | 3.5 | 86 | 0.91 | 142 | 98 | 69.0 |
| Example A-2 | 4 | 3.5 | 90 | 0.16 | 149 | 146 | 98.0 |
| Example A-3 | 4 | 3.5 | 91 | 0.15 | 145 | 141 | 97.2 |
| Example A-4 | 4 | 3.5 | 88 | 0.15 | 143 | 139 | 97.2 |
| Example A-5 | 4 | 3.5 | 63 | 0.14 | 138 | 123 | 89.1 |
| Example A-6 | 4.5 | 4 | 81 | 0.12 | 140 | 135 | 96.4 |
| Example A-7 | 3.5 | 3.5 | 69 | 0.15 | 128 | 85 | 66.4 |
| Example A-8 | 4.5 | 4 | 78 | 0.13 | 139 | 133 | 95.7 |
| Example A-9 | 4 | 3 | 66 | 0.11 | 137 | 131 | 95.6 |
| Example A-10 | 4 | 3 | 61 | 0.11 | 133 | 127 | 95.5 |
| Example A-11 | 4 | 3.5 | 91 | 0.34 | 150 | 131 | 87.3 |
| Example A-12 | 4.5 | 4 | 78 | 0.23 | 141 | 134 | 95.0 |
| Example A-13 | 4.5 | 4 | 57 | 0.22 | 122 | 118 | 96.7 |
| Example A-14 | 2.5 | 2 | 92 | 0.89 | 150 | 147 | 98.0 |

TABLE 4

| | | | | | Discharge | Discharge | Rate |
|---|---|---|---|---|---|---|---|
| | pH | pH | | | capacity | capacity | characteristic |
| | before | after | β ratio | D50 | (mAh/g) | (mAh/g) | (%) (0.1 C/ |
| | reaction | reaction | (%) | (μm) | 0.01 C | 0.1 C | 0.01 C) |
| Comparative | 4 | 3 | 85 | 1.03 | 141 | 75 | 53.2 |
| Example A-1 | | | | | | | |
| Comparative | 4 | 3 | 23 | 0.13 | 87 | 54 | 62.1 |
| Example A-2 | | | | | | | |
| Comparative | 4 | 3 | 82 | 2.3 | 140 | 36 | 25.7 |
| Example A-3 | | | | | | | |
| Comparative | 7 | 6 | 32 | 1.5 | 110 | 67 | 60.9 |
| Example A-4 | | | | | | | |
| Comparative | 4 | 3.5 | 92 | 1.2 | 150 | 83 | 55.3 |
| Example A-5 | | | | | | | |

The active materials obtained in Examples A-1 to A-14 were LiVOPO₄ having a β-type crystal structure. The average primary particle diameters (D50) of the obtained active materials were smaller than 1,000 nm. The cells using electrodes containing the active materials displayed large discharge capacities with high rate characteristics. In Example A-14 where the reducing agent was used, the ratio of LiVOPO₄ having a β-type crystal structure occupying the active material was highest and a large discharge capacity with the highest rate characteristic was shown.

Comparison was made between Example A-2 where heating was conducted in an air atmosphere at the firing step and Example A-7 where heating was conducted in an argon atmosphere. In Example A-2 where heating was conducted in an air atmosphere, a greater discharge capacity with a higher rate characteristic was obtained.

As has been apparent from Examples A-1 to A-14 and Comparative Examples A-1 to A-5, LiVOPO₄ having a β type crystal structure accompanied by a large discharge capacity with a high rate characteristic can be obtained by hydrothermally synthesizing a mixture containing a water-soluble polymer with a molecular weight in a specified range wherein the ratio of the total mole number of repeating units of the whole water-soluble polymer to the mole number of the vanadium atoms has been adjusted to a specified range and by firing the mixture.

### Example B-1

### Hydrothermal Synthesis Step

To a 500 ml Erlenmeyer flask, 4.63 g (0.04 mol) of H₃PO₄ (product of NACALAI TESQUE, INC with a purity of 85%) and 180 g of distilled water (product of NACALAI TESQUE, INC for use in HPLC) were charged and agitated with a magnetic stirrer. Subsequently, 3.67 g (0.02 mol) of V₂O₅ (product of NACALAI TESQUE, INC with a purity of 99%) was added to the mixture and agitation continued for about 2.5 hr. Next, 1.77 g (0.01 mol) of ascorbic acid was added to the above mixture. After addition of ascorbic acid, agitation continued for about 60 min. Subsequently, 1.70 g (0.04 mol) of LiOH.H₂O (product of NACALAI TESQUE, INC with a purity of 99%) was added to the mixture over a period of about 10 min. After 20 g of distilled water had been further added to the resulting paste substance, 210.91 g of the substance in the flask was transferred to a 0.5 L cylindrical container made of glass for autoclave. When the pH of the substance in the container was measured, it was found to be 5. The container was hermetically closed and was held at 250° C. for 12 hr to carry out hydrothermal synthesis.

After the heater had been switched off, cooling by standing was carried out over about 7 hr to produce a suspension containing dark brown precipitates. When the pH of this substance was measured, it was found to be 6. After removal of the supernatant, about 200 ml of distilled water was added to the substance and the precipitates within the container were washed under agitation. Then, suction filtration was conducted. After having conducted washing, about 200 ml of acetone was added and washed the precipitates similarly to water-washing. After filtration, the substance was transferred to a stainless petri dish and dried in the air to produce 6.51 g of brown solid. The yield was 96.7% when converted as LiVOPO₄.

(Firing Step)

The brown solid obtained in the hydrothermal synthesis step, 1.00 g, was placed in an alumina crucible, temperature was raised from room temperature to 450° C. over 60 min in an air atmosphere and the solid was heat-treated at 450° C. for 4 hr to yield a powder.

(Measurement of β Ratio)

With respect to the active material according to Example B-1, the ratio (β ratio) of the β-type crystal structure to the total of LiVOPO₄ having a β-type crystal structure and LiVOPO₄ having an α-type crystal structure was determined from the results of powder X-ray diffraction (XRD). The β ratio of the active material according to Example B-1 was 97%.

(Measurement of Average Primary and Secondary Particle Diameters)

The particle size distribution of the primary and secondary particles of the active material according to Example B-1 was calculated in terms of the cumulative percentage of the diameter of an equivalent circle for projected area derived from the projected area of the active material (each 100 particles) that is based on the image observed under a high resolution scanning electron microscope. The average primary particle diameter (D50) and the average secondary particle diameter (D50) of the active material were calculated in accordance with the calculated particle size distribution based on the numbers of the active material. The average primary particle diameter (D50) of the active material was 160 nm and the average secondary particle diameter (D50) of the active material was 2,200 nm. Further, the D10 value at which the cumulative percentage in the particle size distribution based on numbers measured for the secondary particles of the active material obtained in Example B-1 was 10% was found to be 1,150 nm,; the D90 value corresponding to a cumulative percentage of 90% was 2,730 nm.

(Measurement of Length of the Short Axis/Length of the Long Axis for Secondary Particle)

Length, of short axises and length of long axises diameters of secondary particles per 100 particles of the active material were measured based on images observed under a high resolution scanning electron microscope, and the average value of the ratios of the length of the short axises to the length of the long axises was calculated. The ratio of the length of the short axis to the length of the long axis for the active material according to Example B-1 was 0.93.

(Measurement of Discharge Capacity)

A slurry was prepared by dispersing a mixture of the active material according to Example B-1, polyvinylidene fluoride (PVDF) as binder and acetylene black in N-methyl-2-pyrrolidone (NMF) as solvent. The slurry was prepared so that the weight ratio among the active material in the slurry, acetylene black and PVDF was 84:8:8. This slurry was applied to an aluminum foil as a collector, and after drying, it was rolled to produce an electrode (positive electrode) on which an active material layer containing the active material according to Example B-1 had been formed.

Next, the obtained electrode, a lithium foil as an opposite electrode were laminated such that a separator comprising a polyethylene macroporous membrane were interposed therebetween, to produce a laminate (element assembly). This laminate was placed in a laminate pack of aluminum and after a 1 M solution of LiPF₆ as electrolyte had been infused to the laminate pack of aluminum, it was sealed under vacuum to prepare an evaluation cell according to Example B-1.

The evaluation cell according to Example B-1 was used to measure a discharge capacity (unit: mAh/g) when the discharge rate was set to 0.01 C (the current value at which the constant current discharging at 25° C. completes in 100 hr). A discharge capacity at 0.01 C was 153 mAh/g. A discharge capacity (unit: mAh/g) when the discharge rate was set to 0.1 C (the current value at which the constant current discharging at 25° C. completes in 10 hr) was measured. The discharge capacity at 0.1 C was 148 mAh/g.

(Evaluation of Rate Characteristic)

The percentage of the discharge capacity at 0.1 C relative to the discharge capacity at 0.01 C was calculated and evaluated as the rate characteristic. The rate characteristic of the evaluation cell according to Example B-1 is 96.7%.

### Examples B-2 to B-15 and Comparative Examples B-1 to B-11

Similarly to Example B-1, active materials according to Examples B-2 to B-15 and Comparative Examples B-1 to B-11 were obtained, except that in the hydrothermal synthesis step, the ratio of the mole number of the lithium atoms to the mole number of the vanadium atoms, the ratio of the mole number of the phosphorus atoms to the mole number of the vanadium atoms, the amount of ascorbic acid to be added to the mixture, the type of a reducing agent, the temperatures of the hydrothermal synthesis step and firing step were changed as shown in Tables 5 and 6 below. The ratio (β ratio) of the β-type crystal structure to the total of LiVOPO₄ having a β type crystal structure and LiVOPO₄ having an α type crystal structure in each of the obtained active materials, the average primary particle diameter (DV50), the average secondary particle diameter (DV50) and the ratio of the length of the long axis to the length of the short axis of the secondary particle for each of the active materials, as well as the discharge capacity and rate characteristic of the evaluation cell using each of the active materials are shown in Tables 7 and 8. Note that the respective ratios of D10 or D90 to D50 for the secondary particles according to Example B-2 to B-15 were values at nearly the same level as that for Example B-1.

TABLE 5

| | | Hydrothermal | | | | | |
|---|---|---|---|---|---|---|---|
| | | synthesis | | Reducing | Heat | pH | pH |
| | | temperature | Reducing | agent ratio | treatment | before | after |
| | L:V:P | (° C.) | agent | (molar ratio) | conditions | reaction | reaction |
| Example B-1 | 1:1:1 | 250 | Ascorbic | 0.25 | Air | 5 | 6 |
| | | | acid | | 450° C. | | |
| | | | | | 4 hr | | |
| Example B-2 | 1:1:1 | 250 | Ascorbic | 0.25 | Air | 5 | 6 |
| | | | acid | | 500° C. | | |
| | | | | | 4 hr | | |
| Example B-3 | 1:1:1 | 250 | Ascorbic | 0.1 | Air | 4.5 | 4 |
| | | | acid | | 500° C. | | |
| | | | | | 4 hr | | |
| Example B-4 | 1:1:1 | 250 | Ascorbic | 0.3 | Air | 5.5 | 5 |
| | | | acid | | 500° C. | | |
| | | | | | 4 hr | | |
| Example B-5 | 1:1:1 | 250 | Ascorbic | 0.5 | Air | 6 | 5 |
| | | | acid | | 500° C. | | |
| | | | | | 4 hr | | |
| Example B-6 | 1:1:1 | 200 | Ascorbic | 0.25 | Air | 5 | 6 |
| | | | acid | | 450° C. | | |
| | | | | | 4 hr | | |
| Example B-7 | 1:1:1 | 210 | Ascorbic | 0.25 | Air | 5 | 6 |
| | | | acid | | 450° C. | | |
| | | | | | 4 hr | | |
| Example B-8 | 1:1:1 | 290 | Ascorbic | 0.25 | Air | 5 | 6 |
| | | | acid | | 450° C. | | |
| | | | | | 4 hr | | |
| Example B-9 | 1:1:1 | 300 | Ascorbic | 0.25 | Air | 5 | 6 |
| | | | acid | | 450° C. | | |
| | | | | | 4 hr | | |
| Example B-10 | 1.2:1:1.2 | 250 | Ascorbic | 0.25 | Air | 5 | 6 |
| | | | acid | | 450° C. | | |
| | | | | | 4 hr | | |
| Example B-11 | 0.95:1:0.95 | 250 | Ascorbic | 0.25 | Air | 5 | 6 |
| | | | acid | | 450° C. | | |
| | | | | | 4hr | | |
| Example B-12 | 1:1:0.95 | 250 | Ascorbic | 0.25 | Air | 5 | 6 |
| | | | acid | | 450° C. | | |
| | | | | | 4 hr | | |
| Example B-13 | 0.95:1:1 | 250 | Ascorbic | 0.25 | Air | 5 | 6 |
| | | | acid | | 450° C. | | |
| | | | | | 4 hr | | |
| Example B-14 | 1:1:1.2 | 250 | Ascorbic | 0.25 | Air | 5 | 6 |
| | | | acid | | 450° C. | | |
| | | | | | 4 hr | | |
| Example B-15 | 1.2:1:1 | 250 | Ascorbic | 0.25 | Air | 5 | 6 |
| | | | acid | | 450° C. | | |
| | | | | | 4 hr | | |

TABLE 6

| | | Hydrothermal | | | | | |
|---|---|---|---|---|---|---|---|
| | | synthesis | | Reducing | Heat | pH | pH |
| | | temperature | Reducing | agent ratio | treatment | before | after |
| | L:V:P | (° C.) | agent | (molar ratio) | conditions | reaction | reaction |
| Comparative | 1:1:1 | 250 | Hydrazine | 0.25 | Air | 4 | 3 |
| Example B-1 | | | | | 600° C. | | |
| | | | | | 4 hr | | |
| Comparative | 1:1:1 | 250 | None | — | Air | 3 | 2.5 |
| Example B-2 | | | | | 600° C. | | |
| | | | | | 4 hr | | |
| Comparative | 1:1:1 | 250 | Ascorbic | 0.01 | Air | 3.3 | 3 |
| Example B-3 | | | acid | | 500° C. | | |
| | | | | | 4 hr | | |
| Comparative | 1:1:1 | 250 | Ascorbic | 1.5 | Air | 6.5 | 7 |
| Example B-4 | | | acid | | 500° C | | |
| | | | | | 4 hr | | |
| Comparative | 1.5:1:1.5 | 250 | Ascorbic | 0.25 | Air | 4 | 5 |
| Example B-5 | | | acid | | 450° C. | | |
| | | | | | 4 hr | | |
| Comparative | 1:1:1.5 | 250 | Ascorbic | 0.25 | Air | 5 | 6 |
| Example B-6 | | | acid | | 450° C. | | |
| | | | | | 4 hr | | |
| Comparative | 1.5:1:1 | 250 | Ascorbic | 0.25 | Air | 5 | 6 |
| Example B-7 | | | acid | | 450° C. | | |
| | | | | | 4 hr | | |
| Comparative | 0.9:1:0.9 | 250 | Ascorbic | 0.25 | Air | 5 | 6 |
| Example B-8 | | | acid | | 450° C. | | |
| | | | | | 4 hr | | |
| Comparative | 1:1:0.9 | 250 | Ascorbic | 0.25 | Air | 5 | 6 |
| Example B-9 | | | acid | | 450° C. | | |
| | | | | | 4 hr | | |
| Comparative | 0.9:1:1 | 250 | Ascorbic | 0.25 | Air | 5 | 6 |
| Example B-10 | | | acid | | 450° C. | | |
| | | | | | 4 hr | | |
| Comparative | 1:1:1 | 250 | Ascorbic | 0.7 | Air | 6.5 | 5.5 |
| Example B-11 | | | acid | | 500° C. | | |
| | | | | | 4 hr | | |

TABLE 7

| | | Average | Average | | | | | |
|---|---|---|---|---|---|---|---|---|
| | | primary | secondary | Secondary | | Discharge | Discharge | Rate |
| | | particle | particle | particle | Solid | capacity | capacity | characteristic |
| | β ratio | diameter | diameter | short axis/ | yield | (mAh/g) | (mAh/g) | (%) (0.1 C/ |
| | (%) | D50 (μm) | D50 (μm) | long axis | (%) | 0.01 C | 0.1 C | 0.01 C) |
| Example B-1 | 90 | 0.16 | 2.2 | 0.93 | 97 | 153 | 148 | 96.7 |
| Example B-2 | 92 | 0.23 | 2.6 | 0.9 | 97 | 155 | 143 | 92.3 |
| Example B-3 | 93 | 0.28 | 7.7 | 0.83 | 95 | 148 | 138 | 93.2 |
| Example B-4 | 90 | 0.14 | 1.9 | 0.86 | 96 | 141 | 137 | 97.2 |
| Example B-5 | 86 | 0.12 | 1.8 | 0.9 | 92 | 135 | 132 | 97.8 |
| Example B-6 | 82 | 0.21 | 2.3 | 0.81 | 90 | 142 | 134 | 94.4 |
| Example B-7 | 88 | 0.13 | 2 | 0.82 | 97 | 145 | 141 | 97.2 |
| Example B-8 | 91 | 0.27 | 3.2 | 0.89 | 97 | 154 | 132 | 85.7 |
| Example B-9 | 89 | 0.34 | 3.8 | 0.81 | 97 | 149 | 120 | 80.5 |
| Example B-10 | 90 | 0.22 | 2.8 | 0.85 | 95 | 143 | 131 | 91.6 |
| Example B-11 | 87 | 0.18 | 2.4 | 0.86 | 93 | 139 | 125 | 89.9 |
| Example B-12 | 88 | 0.18 | 2.5 | 0.84 | 94 | 140 | 127 | 90.7 |
| Example B-13 | 88 | 0.17 | 2.3 | 0.83 | 94 | 140 | 126 | 90.0 |
| Example B-14 | 91 | 0.25 | 3 | 0.82 | 95 | 145 | 133 | 91.7 |
| Example B-15 | 91 | 0.21 | 2.4 | 0.83 | 95 | 141 | 135 | 95.7 |

TABLE 8

| | | Average | Average | | | | | |
|---|---|---|---|---|---|---|---|---|
| | | primary | secondary | Secondary | | Discharge | Discharge | Rate |
| | | particle | particle | particle | Solid | capacity | capacity | characteristic |
| | β ratio | diameter | diameter | short axis/ | yield | (mAh/g) | (mAh/g) | (%) (0.1 C/ |
| | (%) | D50 (μm) | D50 (μm) | long axis | (%) | 0.01 C | 0.1 C | 0.01 C) |
| Comparative | 89 | 2.3 | 16 | 0.75 | 57 | 139 | 75 | 54.0 |
| Example B-1 | | | | | | | | |
| Comparative | 21 | 2.5 | 20 | 0.63 | 83 | 82 | 56 | 68.3 |
| Example B-2 | | | | | | | | |
| Comparative | 37 | 2.5 | 18 | 0.78 | 84 | 99 | 53 | 53.5 |
| Example B-3 | | | | | | | | |
| Comparative | 52 | 0.1 | 1.5 | 0.79 | 89 | 126 | 114 | 90.5 |
| Example B-4 | | | | | | | | |
| Comparative | 86 | 0.34 | 4.3 | 0.69 | 92 | 133 | 113 | 85.0 |
| Example B-5 | | | | | | | | |
| Comparative | 83 | 0.45 | 3.1 | 0.61 | 91 | 136 | 108 | 79.4 |
| Example B-6 | | | | | | | | |
| Comparative | 64 | 0.2 | 3.5 | 0.76 | 83 | 133 | 104 | 78.2 |
| Example B-7 | | | | | | | | |
| Comparative | 83 | 0.17 | 2.5 | 0.77 | 85 | 128 | 106 | 82.8 |
| Example B-8 | | | | | | | | |
| Comparative | 65 | 0.33 | 3.6 | 0.73 | 76 | 96 | 56 | 58.3 |
| Example B-9 | | | | | | | | |
| Comparative | 68 | 0.39 | 4.6 | 0.65 | 63 | 83 | 36 | 43.4 |
| Example B-10 | | | | | | | | |
| Comparative | 82 | 0.1 | 1.6 | 0.78 | 86 | 125 | 110 | 88.0 |
| Example B-11 | | | | | | | | |

As Table 7 shows, the active materials produced under the conditions of Examples B-1 to B-15 had average primary particle diameters of from 120 to 340 nm. The ratios of the length of short axises to the length of long axises for the secondary particles were from 0.81 to 0.99 and the secondary particles were aggregates that were very close to spheres. Further, these active materials contained LiVOPO₄ having a β-type crystal structure as principal components. The cells using the active materials according to Examples B-1 to B-15 displayed large discharge capacities with high rate characteristics.

What is claimed is:

1. A method for manufacturing an active material comprising:
a hydrothermal synthesis step of heating under pressure, a mixture containing a lithium source, a vanadium source, a phosphoric acid source, water and a water-soluble polymer having a weight average molecular weight of from 200 to 100,000,
wherein the ratio of the total mole number of repeating units of the whole water-soluble polymer to the mole number of the vanadium atoms is from 0.02 to 1.0, to produce a precursor of LiVOPO₄ having a β-type crystal structure; and
a firing step of heating the precursor of LiVOPO₄ having a β-type crystal structure to obtain LiVOPO₄ having a β-type crystal structure.

2. The method according to claim 1, at the firing step, the precursor of LiVOPO₄ having a β-type crystal structure after the hydrothermal synthesis step is heated in an air atmosphere.

3. The method according to claim 1, wherein the energy level of the Highest Occupied Molecular Orbital of the water-soluble polymer is lower than −9.6 eV.

4. The method according to claim 1, wherein the water-soluble polymer comprises at least one selected from the group consisting of polyethylene glycol, copolymer of vinyl methyl ether and maleic acid anhydride, and polyvinylpyrrolidone.

5. The method according to claim 1, at the hydrothermal synthesis step, a reducing agent is further added to the mixture.

6. A method for manufacturing an active material comprising:
a hydrothermal synthesis step of heating under pressure, a mixture containing a lithium source, a vanadium source, a phosphoric acid source, water and ascorbic acid,
wherein the ratio of the mole number of the lithium atoms to the mole number of the vanadium atoms and the ratio of the mole number of the phosphorus atoms to the mole number of the vanadium atoms are both from 0.95 to 1.2, and the ratio of the mole number of the ascorbic acid to the mole number of the vanadium atoms to is from 0.05 to 0.6; and
a firing step of heating the material produced at the hydrothermal synthesis step to obtain LiVOPO₄ having β-type crystal structure.

7. An active material comprising as a principal component, LiVOPO₄ having a β-type crystal structure, the active material having an average primary particle diameter of from 100 to 350 nm and having an aggregate structure wherein the ratio of the length of the short axis to the length of the long axis in a secondary particle is from 0.80 to 1.

8. The active material according to claim 7, wherein the average secondary particle diameter is from 1,500 nm to 8,000 nm.

9. An electrode comprising;
a collector and;
an active material layer containing the active material according to claim 7, wherein the active material layer is disposed on the collector.

10. A lithium secondary battery comprising the electrode according to claim 9.
